(19) United States
(12) Patent Application Publication
(10) Pub. No.: US 2002/0169940 A1
(43) Pub. Date: Nov. 14, 2002

(54) System and method for using memory mapping to scan a master file table

(76) Inventor: Daniel B. Kyler, Colorado Springs, CO (US)

Correspondence Address: Supervisor, Patent Prosecution Services, PIPER RUDNICK LLP, 1200 Nineteenth Street, N.W., Washington, DC, 20036-2412, US

(21) Appl. No.: 10/120,502

(22) Filed: Apr. 12, 2002

Related U.S. Application Data
(60) Provisional application No. 60/283,272, filed on Apr. 12, 2001.

(51) Int. Cl. G06F 15/00

(52) U.S. Cl. 712/1

(57) ABSTRACT

An efficient system and method for file information access to millions of files referenced in the NTFS File Volume Directory (MFT) for a very large NTFS File Volume. The MFT is read to create a List of all the NTFS Files on the NTFS Volume. In addition, the List of NTFS Files from the MFT is read to get the NTFS File attribute information, including information not available in the directory structure. The present invention uses the following method: the User specifies the type of information he wants about the NTFS Files; the MFT Fast Scan API reads the MFT to copy the NTFS File Records; the MFT Fast Scan API parses the NTFS Records; the MFT Fast Scan API puts the NTFS File Records in a more usable format; and the MFT Fast Scan API returns the information to the User.

This application claims priority from U.S. Provisional Application Serial No. 60/283,272 filed Apr. 12, 2001. The entirety of that provisional application is incorporated herein by reference.

### BACKGROUND OF THE INVENTION

1. Field of the Invention

The present invention relates generally to the management of computer disk space, and relates particularly to methods for efficient access to information about files stored on computer disk space.

2. Background of the Technology

With the increasing use and sophistication of technology, management of computer disk space, and particularly methods for efficient access to information about files stored on computer disk space, has become more challenging. Due to the increased size of volumes (specifically in the number of files on the volume), accessing file information has become more and more time consuming. The present invention is used on an Operating System. An Operating System can include a File Structure, a File Volume, a File Volume Directory, Files, and File Folders. A File Structure is a description of a group of files that are to be treated together for some purpose. One embodiment of the File Structure is Microsoft's New Technology File System (NTFS). A File Volume is a disk that stores Files. One embodiment of the File Volume is an NTFS Volume, which is a volume of files that uses the NTFS. A File Volume Directory is a directory of all the Files on the File Volume. One embodiment of the NTFS File Volume Directory is a Master File Table (MFT). A File is a complete, named collection of information, such as a program, a set of data used by a program, or a user-created document. One embodiment of the File is an NTFS File, which is a File within the NTFS Volume. A File Directory is a directory that contains information on a particular set of Files. One embodiment of the File Directory is the NTFS File Folder.

The prior art uses a Search Engine to search a NTFS Volume for information on the NTFS Files by: opening each NTFS Folder; opening each NTFS File in each NTFS Folder; and querying the NTFS File for the File attribute information of the associated NTFS File. Thus, for example, if an Operating System had a NTFS Volume with 200,000 NTFS Files in 10,000 Folders, the Search Engine would: open each one of the 10,000 NTFS Folders; open the NTFS File in each of the NTFS Folders; and query the NTFS File for the NTFS File attribute information. This approach is very slow and inefficient.

### SUMMARY OF THE INVENTION

The present invention solves the above needs by providing an efficient method for file information access to large numbers of files referenced in the NTFS File Volume Directory (MFT) for a very large NTFS File Volume. There is one MFT for every NTFS Volume, and the MFT has one Record for every file on the File Volume. The MFT preserves the structure information showing how each of the NTFS Files are related on the NTFS File Volume.

The present invention uses the MFT instead of the NTFS File Directories. The present invention reads the MFT to create a List of all the NTFS Files on the NTFS Volume. This process is substantially, and in some instances, at least 10 times faster than the process of using the directory structure of the NTFS Volume to create the List of NTFS Files. In addition, the present invention uses this List of NTFS Files from the MFT to get the File attribute information, including information not available in the directory structure. This process is substantially, and in some instances, at least 100 times faster than obtaining the extended attribute information by examining each NTFS File.

The present invention comprises an Operating System, a File Structure (NTFS), a File Volume (NTFS File Volume), a File Volume Directory (MFT), File, a File Directory (File Folder), and a MFT Fast Scan Application Programing Interface (API).

The MFT Fast Scan API provides an efficient method for file information access to millions of files referenced in the File Volume Directory (MFT) for a very large File Volume.

The present invention uses the following method: the User specifies the type of information he wants about the NTFS Files; the MFT Fast Scan API reads the MFT to copy the NTFS File Records; the MFT Fast Scan API parses the NTFS Records; the MFT Fast Scan API puts the NTFS File Records in a more usable format; and the MFT Fast Scan API returns the information to the User.

### DESCRIPTION OF THE DRAWINGS

The foregoing and other objects, aspects and advantages will be better understood from the following detailed description of a preferred embodiment of the invention with reference to the drawings, in which:

FIG. 1 is a block diagram showing the main components in accordance with an exemplary embodiment of the present invention.

FIG. 2 illustrates a method of operation for the MFT Fast Scan API in accordance with an exemplary embodiment of the present invention.

FIG. 3 illustrates a method of operation for the MFT Fast Scan API in accordance with an example of the present invention.

### DETAILED DESCRIPTION OF THE INVENTION

System Overview

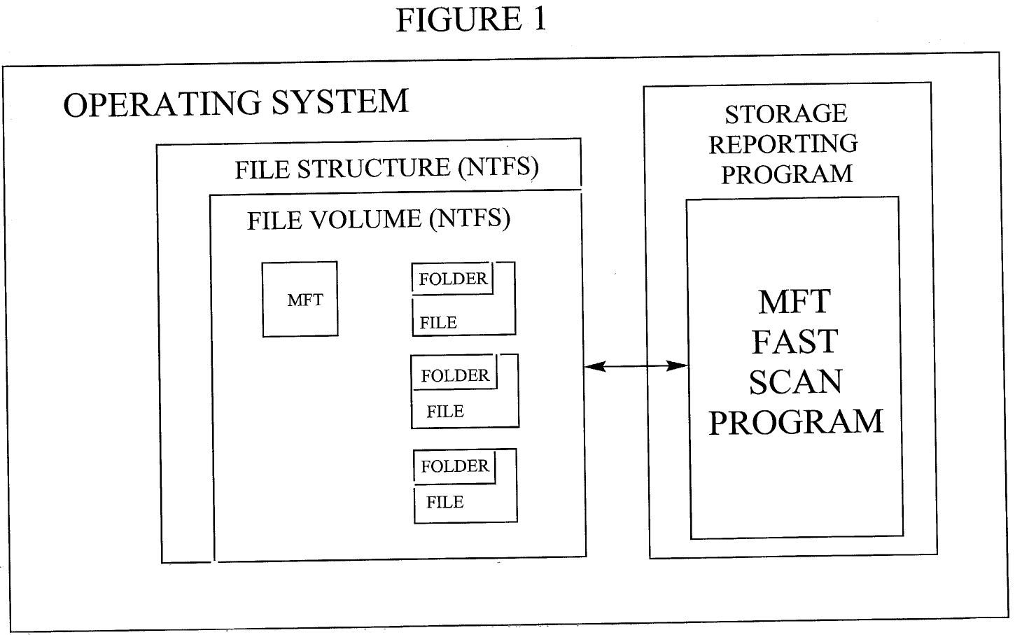

FIG. 1 is a block diagram showing the main components in accordance with an exemplary embodiment of the present invention.

The present invention comprises: an Operating System, a File Structure (NTFS), a File Volume (NTFS File Volume), a File Volume Directory (MFT), File, a File Directory (File Folder), and a MFT Fast Scan API.

An Operating System is software that controls the allocation and usage of hardware resources, such as memory and disk space. The Operating System can be a 32-bit self-contained multitasking system, and can feature networking, symmetric multiprocessing, multithreading and security features. An Operating System can include a File Structure, a File Volume, a File Volume Directory, Files, and File Folders.

A File Structure is a description of a group of files that are to be treated together for some purpose. One embodiment of the File Structure is a New Technology File System (NTFS), which is an object-oriented file structure pioneered by Microsoft in connection with Windows NT and Windows 2000 operating systems. The NTFS is not limited to the Windows NT and Windows 2000 platforms, but these platforms will be used in describing the preferred embodiment. NTFS supports long filenames, full security access control, file system recovery, extremely large storage media, and various features. It supports object-oriented applications by treating all files as objects with user-defined and system-defined attributes.

A File Volume is a disk that stores Files. One embodiment of the File Volume is an NTFS Volume, which is a volume of files that uses the NTFS. The NTFS Volume has a number of advanced features, including: support for long file names; full security access control; and an ability to handle extremely large storage media.

A File Volume Directory is a directory of all the Files on the File Volume. One embodiment of the NTFS File Volume Directory is a Master File Table (MFT). A Master File Table (MFT) is a volume directory, established by the operating system, for all the files in the NTFS Volume. Disk space management programs typically use MFTs to monitor use of disk space. There is one MFT for every NTFS Volume, and the MFT has one Record for every file on the NTFS volume. The MFT preserves the structure information showing how each of the NTFS Files are related on the NTFS File Volume. The MFT Records contains all information about a NTFS File, including: size; time and date stamps; permissions; and information about data content. Small files and directories (typically 32 bytes or smaller) can be contained entirely within the MFT. In this application, the operating system's directory or index will be referred to as an MFT, which is one embodiment. However, other embodiments, such as INDEXF.SYS may also be used, and the use of this term should not be interpreted as limiting the use of the present invention to the MFT embodiment.

A File is a complete, named collection of information, such as a program, a set of data used by a program, or a user-created document. The File is the basic unit of storage that enables a computer to distinguish one set of information from another. One embodiment of the File is an NTFS File, which is a File within the NTFS Volume.

A File Directory is a directory that contains information on a particular set of Files. The File attribute information is accessed by scanning the File Directory. One embodiment of the File Directory is the NTFS Folder. An NTFS File Folder is a directory for the associated NTFS Files.

The MFT Fast Scan API is a scan disk API that provides an efficient method for file information access to very large numbers of files referenced in the File Volume Directory (MFT) for a very large File Volume.

The User of the present invention is usually a programmer who writes an application which uses the MFT Fast Scan API. The User of the resulting application is usually be the system administrator.

Method Overview

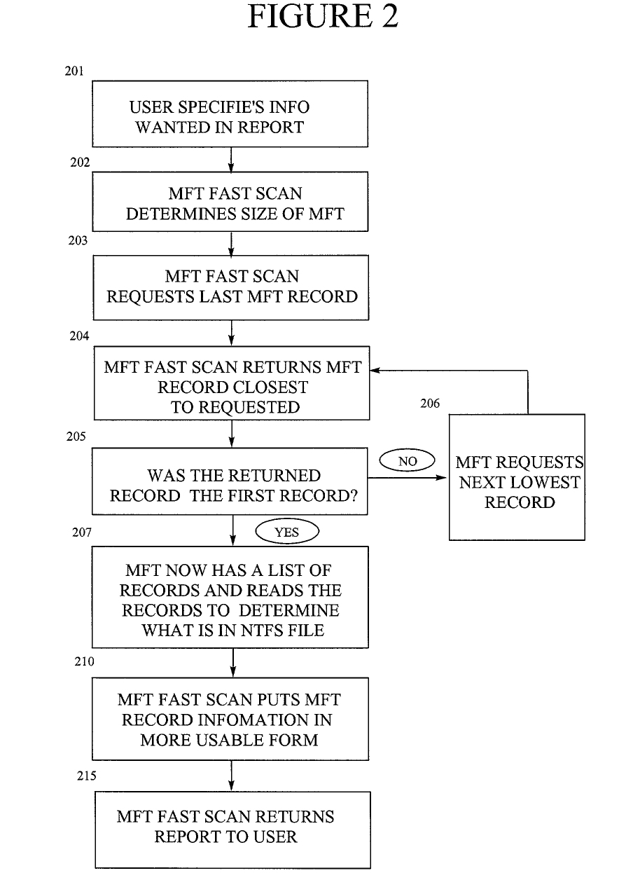

FIG. 2 illustrates a method of operation for the MFT Fast Scan API in accordance with an exemplary embodiment of the present invention.

The present invention uses the following method: the User specifies the type of information he wants about the NTFS Files (step 201); the MFT Fast Scan API reads the MFT to copy the NTFS File Records (steps 202-206); the MFT Fast Scan API parses the NTFS Records (step 207); the MFT Fast Scan API puts the NTFS File Records in a more usable format (step 210); and the MFT Fast Scan API returns the information to the User (step 215).

In step 201, the User accesses the UI to specify types of information he wants in the Report. The types of information include fields he wants to see, how to sort the Report, and how to filter the Report.

In step 202, the MFT Fast Scan API determines the size of the MFT by asking the NTFS Volume for the total number of NTFS Files. This indicates that there is room to describe this number of MFT Records in the MFT. The MFT Records can be used or unused.

In step 203, the MFT Fast Scan API requests the last MFT Record.

In step 204, the MFT Fast Scan API returns the MFT Record closest to what was requested. If the last MFT Record is available, the MFT Fast Scan API returns the last MFT Record. However, the last MFT Record may be an unused MFT Record. In this case, the MFT Fast Scan API will return the used MFT Record closest to (and less than) the number of the requested MFT Record.

In step 205, the MFT Fast Scan API determines if the returned MFT Record was the first MFT Record. If YES, the process skips to step 207. If NO, the process moves to step 206.

In step 206, the MFT Fast Scan API requests the next lowest MFT Record. The process then moves to step 204 and repeats.

In step 207, after the MFT Fast Scan API has returned all the MFT Records in the MFT, the MFT Fast Scan API now has a List of NTFS Files in the NTFS File Volume. The MFT Fast Scan API then reads the MFT Records in the List to determine what is in the NTFS Files. The MFT Fast Scan API parses the MFT Record for the MFT Record Information. The MFT Record Information describes the associated NTFS File Information and comprises: file name, file size, file ownership, security information, and other file attributes.

In step 210, the MFT Fast Scan API puts the MFT Record Information in a more usable form. In step 335, the MFT Fast Scan API copy the MFT Record and the address of the routine that it wants to be called for each MFT Record. The MFT Fast Scan API now has the NTFS File Information (equivalent to the MFT Record Information) in a more usable form for the Report.

A more usable form is helpful because the MFT Record Information is returned in reverse order (e.g., last Record first). This is often not a useful order. Thus, the MFT Fast Scan API will store the information in the original reverse order and then apply various sorts and filters to the information before presenting it to the User.

In step 215, the MFT Fast Scan API returns the Report to the User. The Report comprises the NTFS File Information.

### EXAMPLE

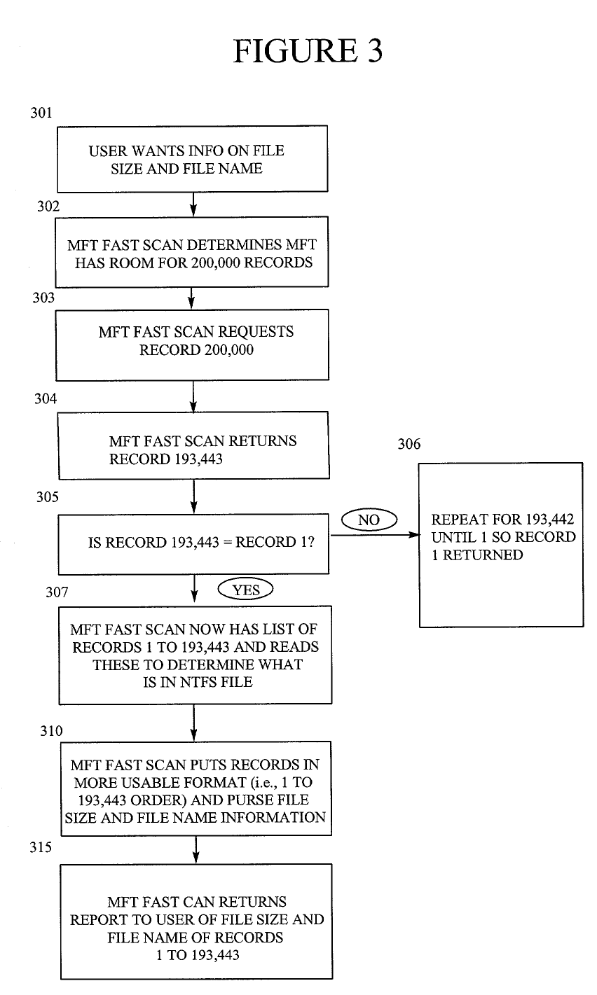

FIG. 3 illustrates a method of operation for the MFT Fast Scan API in accordance with an example of the present invention.

In step 301, the User wants to run a Report to get information about files he can get rid of to free up more storage space. Thus, he wants information on how big certain files are and what is in the files (i.e., file size and file name).

In step 302, the MFT Fast Scan API determines the size of the MFT file by asking the NTFS Volume for the total number of Records, which is 200,000. This indicates that there is room to describe 200,000 Records in the MFT.

In step 303, the MFT Fast Scan API requests Record 200,000.

In step 304, the MFT Fast Scan API returns Record 193,444. Because Record 200,000 is unavailable, 193,444 is the used Record closest to (and less than) the Record 200,000, which was the requested Record.

In step 305, the MFT Fast Scan API determines if MFT Record 193,444 was the first Record. It is not, so the process moves to step 306, where the MFT Fast Scan API requests Record 193,443. The process then moves back up to step 303 and repeats. Thus, in step 303, the MFT Fast Scan API requests Record 193,443. In step 304, the MFT Fast Scan API returns Record 193,443. In step 305, the MFT Fast Scan API determines that 193,443 is not the first Record, and so the process again repeats. This is done until Records 193,442 through Record 1 is returned, and the process skips to step 307.

In step 307, after the MFT Fast Scan API has returned MFT Records 193,444 to 1, the MFT Fast Scan API reads the MFT Records to determine what is in the NTFS file. The MFT Fast Scan API has the MFT Record, so it parses the MFT Record for the corresponding NTFS File Information. The MFT Record Information describes the NTFS File Information and comprises: file name, file size, file ownership, security information, and other file attributes.

In step 310, the MFT Fast Scan API puts the list of NTFS File Information in a more usable format as explained above. Thus, the Records that were originally in order 193,444 to 1, will be put in order 1 to 193,444. The NTFS File Information pulled from the MFT Records will also be filtered to display only file size and file name, which was the criteria the User requested.

In step 315, the MFT Fast Scan API returns the file name and file size information of all the NTFS Files to the User.

While the invention has been described in terms of a single preferred embodiment, those skilled in the art will recognize that the invention can be practiced with modification within the spirit and scope of the appended claims.

What is claimed is:

1. A computer-implemented method for accessing File Information, comprising the steps of:
scanning a Directory, the Directory containing Records with the File Information on each of a plurality of Files on a File Volume, and the Directory preserving structure information showing how each of the plurality of Files are related on the File Volume;
parsing the Records for the File Information; and
translating the File Information to a more usable form.

2. The method of claim 1, further comprising:
allowing a User to request specific File Information that will initiate the scan; and
providing the requested File Information to the User.

3. The method of claim 1, wherein scanning the Directory for the Records further comprises:
determining the size of the Directory by asking the File Volume for the total number of Files;
requesting the last Record corresponding to the last File;
returning the Record closest to the requested Record, but not greater than the requested Record;
determining if the returned Record is a first Record;
if the Record is not the first Record, requesting another Record;
repeating the requesting and returning of the Records until the first Record is returned; and
when the first Record is returned, moving to the parsing the Records step.

4. A computer-implemented system for accessing File Information, comprising:
an operating system;
a File Volume containing Files;
a Directory of the Files in the File Volume; and
a Scan Application Programming Interface for initiating a scan of the Directory;
wherein a scan of a Directory is initiated, the Directory containing Records with the File Information on each of a plurality of Files on a File Volume, and the Directory preserving structure information showing how each of the plurality of Files are related on the File Volume;
the Directory is scanned for the Records, respective to the initiating step;
the Records are parsed for the File Information; and
the File Information is translated to a more useable form.

5. The system of claim 4, wherein:
a User is allowed to request specific File Information that will initiate the scan; and
the requested File Information is returned to the User.

6. The system of claim 4, wherein the scanning of the Directory for the Records further comprises:
determining the size of the Directory by asking the File Volume for the total number of Files;
requesting the last Record corresponding to the last File;
returning the Record closest to the requested Record, but not greater than the requested Record;
determining if the returned Record is the first Record;
if the Record is not the first Record, requesting the next lowest Record;
repeating the requesting and returning of the Records until the first Record is returned; and
when the first Record is returned, moving to the pursing.

7. The system of claim 4, further comprising a File Structure.

8. The system of claim 4, further comprising File Directories.
